(19) United States
(12) Patent Application Publication
(10) Pub. No.: US 2011/0063312 A1
(43) Pub. Date: Mar. 17, 2011

(54) Enhancing Picture Quality of a Display Using Response Time Compensation

(76) Inventor: Sunkwang Hong, Yardley, PA (US)

(21) Appl. No.: 12/558,017

(22) Filed: Sep. 11, 2009

(51) Int. Cl. G06T 1/60

(52) U.S. Cl. 345/530

(57) ABSTRACT

Herein described are at least a method and a system to enhance the display of video by using response time feedback compensation. The system and method may be used in a display within a television set, for example. The method comprises processing first image data gray level values from a first frame memory and processing second image data gray level values from a second frame memory, wherein the second image data gray level values are obtained one frame period prior to the first image data gray level values. The method further comprises outputting alternate image data from a second look-up table, wherein the second look-up table uses third image data gray level values from a third frame memory and current input image data gray level values obtained from a current frame. An exemplary system comprises one or more circuits operable for, at least performing the aforementioned method.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

A liquid crystal display (LCD) may have a slow response time as it attempts to display a moving image during a certain frame refresh period. As a consequence, the picture quality may suffer as the LCD is unable to adequately display a video image from one frame to a next frame.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Various aspects of the invention provide a method and a system of enhancing picture quality of a display by way of using response time compensation. The various aspects and representative embodiments of the method and system are substantially shown in and/or described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a system block diagram of a two-frame response time feedback compensation circuitry in accordance with an embodiment of the invention.

FIG. 2 is a system block diagram of an N-frame response time feedback compensation circuitry in accordance with an embodiment of the invention.

FIG. 3 is an operational flow diagram of an N-frame response time feedback compensation circuitry performing response time compensation to compensate for the slow response time of a typical display.

FIG. 4 is a system block diagram of a switchable response time compensation circuitry (SRTCC) in accordance with an embodiment of the invention.

### DETAILED DESCRIPTION OF THE INVENTION

Various aspects of the invention can be found in a method and a system of compensating for response time inadequacies of a liquid crystal display (LCD) when displaying video using a television set or monitor. For example, a television set having a 60 Hz refresh rate has a period of 16.67 milliseconds. For example, if it takes an average of 30 milliseconds for the LCD to respond to average gray level transitions from one frame to the next frame, the LCD will be unable to attain the desired gray levels. Generally, if the liquid crystal display is unable to make the desired gray level transitions within a refresh period, the picture quality will suffer.

Various aspects of the invention compensate for response time inadequacies in a display, such as in a liquid crystal display (LCD) television, for example. Since refresh rates have generally increased from 60 Hz to 120 Hz or 240 Hz, for example, it is important to be able to provide a solution to compensate for a display's response time given smaller frame refresh periods. In order to correct such inadequacies, a plurality of look-up tables (LUTs) may be used to overdrive the liquid crystal display to compensate for the LCD's slow response time. One or more look-up tables (LUTs) may be used to store adjusted gray level values of the image data in a frame. In order to attain the desired gray level values for the image data in a frame, the gray level values of the image (i.e., the pixels) are mapped to alternate gray level values stored in a LUT. The alternate gray level values may be determined by intercepting the received image from a frame and adjusting the gray levels of the image data in the frame accordingly. The alternate gray level values may be adjusted larger than the intercepted gray level values in order to compensate for the slow response time of the LCD. The alternate gray level values stored in the look-up table (LUT) may be generated experimentally based on the amount of the transition between gray levels and the refresh period. The alternate gray level values that are read from a look-up table (LUT) may allow one to “overdrive” the a liquid crystal display (LCD) such that the desired gray level values are attained during a particular frame period. Thus, in order to compensate for the slow response time of an LCD, the gray level values of a previous frame and a current frame may be used to map an “overdrive” value found in a look-up table (LUT). In a representative embodiment, a number of look-up tables (LUTs) may be implemented in a feedback configuration using one or more frame memories. In a representative embodiment, the number of LUTs and frame memories used may depend on the preciseness of the compensation desired. The circuitry that is used to compensate for the response time inadequacies of a display may be termed a response time feedback compensation circuitry. The response time feedback compensation circuitry may comprise a number of look-up tables (LUTs) and frame memories. The response time feedback compensation circuitry may be located in front of a video scaler, for example. The video scaler comprises a device for converting video signals from one size or resolution to another. The video scaler receives video data from an antenna/set-top box, for example. In addition to an LCD display, the various aspects of the invention may be employed in any display such as a plasma display panel (PDP) or an organic light emitting diode (OLED) display.

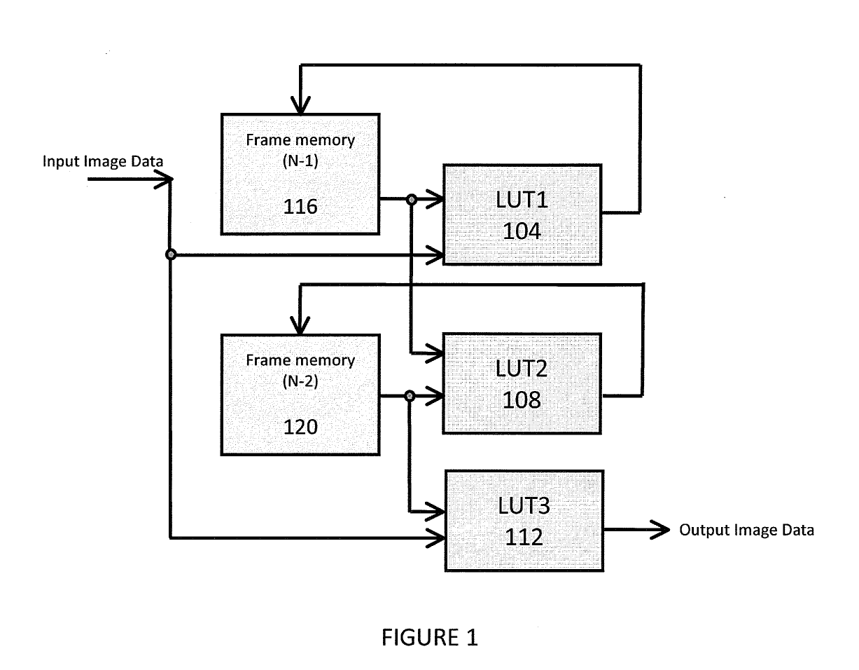

FIG. 1 is a system block diagram of a two-frame response time feedback compensation circuitry in accordance with an embodiment of the invention. The response time feedback compensation circuitry employs two frame memories 116, 120 and three look-up tables 104, 108, 112. The frame memory (N-1) 116 stores gray level values output by LUT1 104 corresponding to the image associated with the frame at frame time N-1. The frame memory (N-2) 120 stores gray level values output by LUT2 108 corresponding to the image associated with the frame at frame time N-2. As illustrated, an input image of a frame may be input into LUT1 104 and LUT3 112. The gray levels of the input image may be specified using 6/8/10 bits. The 6/8/10 bits may be used to specify gray level values for each pixel of an image in each frame. Each look-up table (i.e., LUT1, LUT2, and LUT3) provides alternate gray level values (image compensated gray level values) based on a frame's gray level values and its next frame's gray level values. As previously mentioned, the alternate values are used to compensate for the slow response time of the LCD. A look-up table (LUT) may use gray level values from a previous frame and compare it to gray level values in a current frame, for example; the LUT then generates a suitable alternate output based on the comparison.

As shown in FIG. 1, an output image is generated by LUT3 and is based on the processing performed by all the look-up tables, LUT1, LUT2, LUT3, over a period of two successive frames. By way of the feedback configuration illustrated in FIG. 1, the response time feedback compensation circuitry is able to successively refine the alternate gray level values generated by LUT1, LUT2, and provide a final alternate gray level output at LUT3. LUT3 112 generates the final resulting alternate gray level image based on feedback related processing performed by LUT1 104 and LUT2 108 and frame memories 116, 120 by way of using two frames. The final alternate gray level values are input into a video scaler which subsequently transmits its output to a display. The display may comprise a liquid crystal display (LCD).

As shown in FIG. 1, each look-up table (LUT) 104, 108, 112 comprises two inputs. LUT1 104 generates alternate gray level values based on the previously stored gray level values in frame memory (N-1) and the input image gray level values at time N, as illustrated in FIG. 1. The frame memory (N-2) 120 stores gray level values it obtains from the output of LUT2 108. LUT2 processes the image gray level values provided from frame memory (N-2) 120 and from frame memory (N-1) 116. LUT2 108 further refines the alternate gray level values using the gray level values from frame memory (N-1) 116 and from frame memory (N-2) 120. LUT3 112 outputs the final alternate gray level values using gray level values from frame memory (N-2) 120 and from the input image gray level values at frame time N.

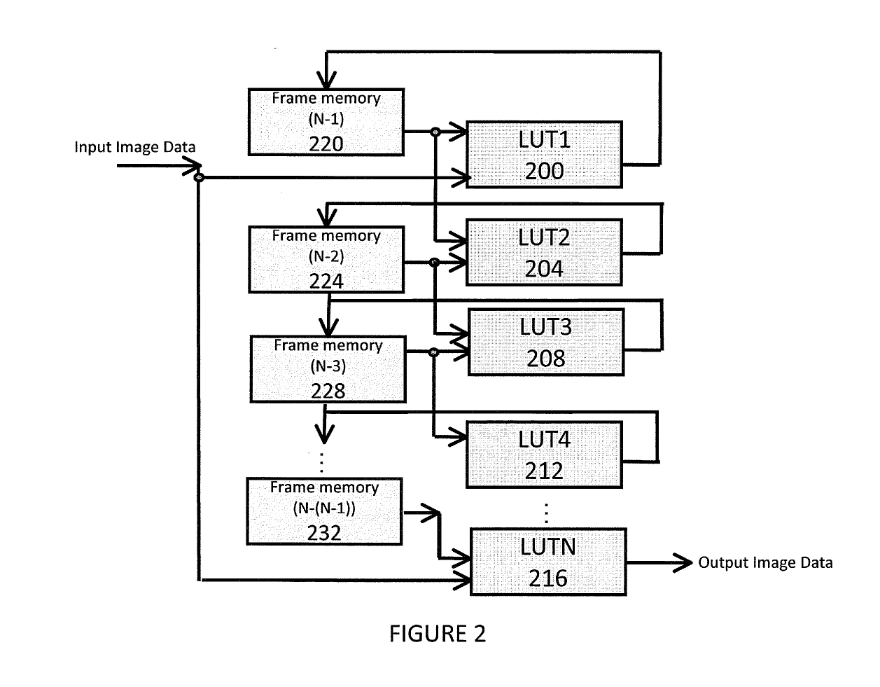

FIG. 2 is a system block diagram of an N-frame response time feedback compensation circuitry in accordance with an embodiment of the invention. The response time feedback compensation circuitry employs N-1 frame memories 220, 224, 228, 232 and N look-up tables 200, 204, 208, 212, 216. The frame memories 220, 224, 228, 232 are used to store the outputs of the look-up tables 200, 204, 208, 212, 216. As was previously stated for the LUTs described in FIG. 1, each look-up table (LUT) provides an alternate gray level value based on its two inputs. The final alternate gray level values provided by LUTN 216 are used to compensate for the slow response time associated with a display, such as a liquid crystal display (LCD). For example, LUT1 200 will compare the gray level values of the current input image data (i.e., gray level values associated with the current frame being input, shown as “input image data” in FIG. 2) to the gray level values of the alternate output of LUT1 for the preceding frame. The output of LUT1 will be recursively stored in frame memory (N-1) 220. In a similar fashion, LUT2 204 outputs alternate gray level values for the input image data based on the gray level values stored in frame memory (N-1) 220 and in frame memory (N-2) 224. Likewise, LUT(N-1) outputs alternate gray level values for the input image data based on gray level values stored in frame memory (N-(N-2)) and in frame memory (N-(N-1)). Furthermore, LUTN outputs alternate gray level values based on gray level values stored in frame memory (N-(N-1)) and the current input image data. Thus, the N-frame response time feedback compensation circuitry provides response time compensation based on N frames. The value for N may be chosen based on an average LCD response time for a gray level transition from one frame to the next frame and the frame refresh rate. For example, N may be set equal to 2 if the average LCD response time is 32 milliseconds and the refresh rate is 60 Hz (i.e., frame period is 16.67 milliseconds). If N=2, the two-frame response time feedback compensation circuitry shown in FIG. 1 would apply. Furthermore, for example, N may be set equal to 4 if the refresh rate is 120 Hz.

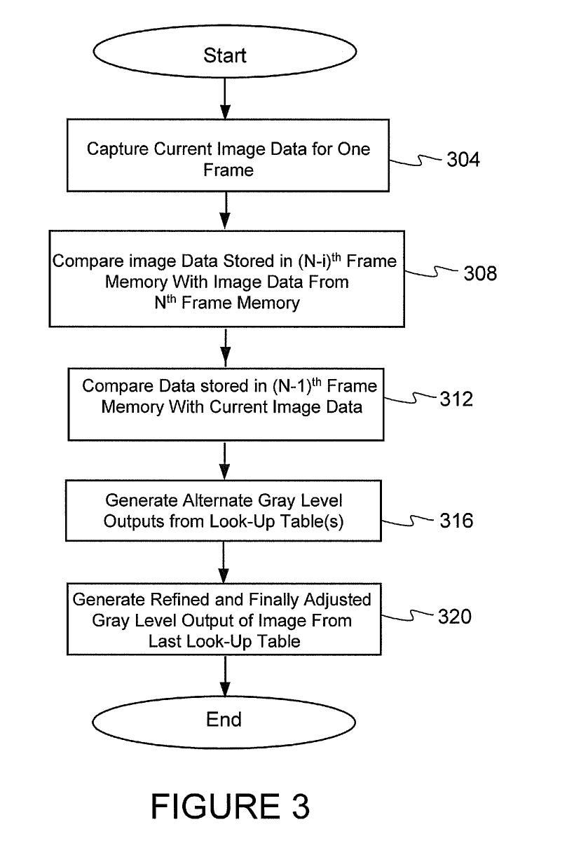

FIG. 3 is an operational flow diagram of an N-frame response time feedback compensation circuitry performing response time compensation to compensate for the slow response time of a typical display. The display may comprise a liquid crystal display (LCD), for example. At step 304, the image data is captured for one frame of video data. The image data may comprise gray levels associated with the pixels of a frame. For example, there may be approximately 2 million pixels presented in a frame when the frame provides a resolution of 1920×1080 pixels. Next, at steps 308 and 312, a look-up table (LUT) is used to compare the gray level (or gray levels of the pixels) of the image data in one frame to the gray level of image data of the previous frame. Alternatively, the gray level of the input image data in the current frame may be compared to the gray level of the image data in the previous frame using a look-up table (LUT). Next, at step 316, the inputs of the one or more LUTs are indexed or mapped to one or more alternate gray level values. The one or more LUTs in the response time feedback compensation circuitry are used to index or map alternate gray level values that are adjusted higher to account for the slow response time of the LCD. The alternate gray level values provided by a LUT of the one or more LUTs may be stored into a frame memory for use in a next frame period. The feedback configuration provided by the response time feedback compensation circuitry allows successive refinement of the alternate gray level values as they are temporally refined using pairs of adjacent frames. Then, at step 320, the last LUT in the string of one or more LUTs generates the output providing the most refined alternate gray level values of the pixels of the image data. The most refined alternate gray level values are provided to the video scaler of a display device. The display device may comprise an LCD television set, for example. The various aspects of the operational flow diagram may be implemented and realized using any type of circuitry or hardware or a combination of hardware and software.

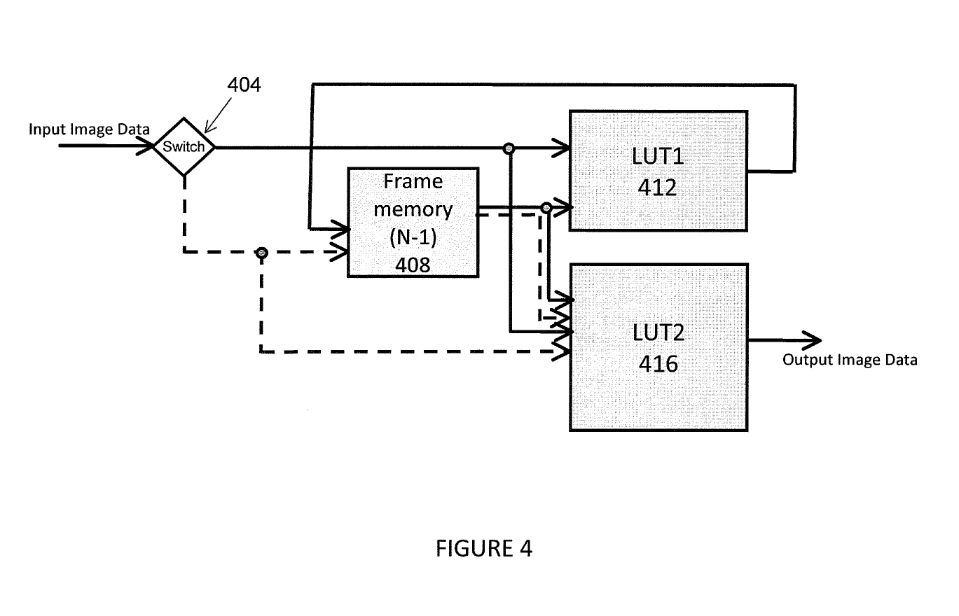

FIG. 4 is a system block diagram of a switchable response time compensation circuitry (SRTCC) in accordance with an embodiment of the invention. The SRTCC comprises a single frame response time compensation circuitry and a single frame response time feedback compensation circuitry. The SRTCC comprises a switch 404, a frame memory (N-1) 408, a first look-up table (LUT1) 412, and a second look-up table (LUT2) 416. The switch 404 is used to switch the input image data between the single frame response time compensation circuitry or the single frame response time feedback compensation circuitry. As illustrated in FIG. 4, the dotted lines indicate the path taken when single frame response time compensation without feedback is used. The solid lines indicate path taken when single frame response time compensation with feedback is used. When the single frame response time compensation circuitry without feedback is selected, the input image is transmitted to the frame memory (N-1) 408 and the second look-up table (LUT2) 416 and the output of the frame memory 408 is transmitted to the second look-up table (LUT2) 416. When the single frame response time compensation circuitry with feedback is selected, the input image is transmitted to both look-up tables 412, 416 and the output of the frame memory (N-1) 408 is transmitted to both look-up tables 412, 416. Furthermore, when the single frame response time compensation circuitry with feedback is selected, the output of the first look-up table (LUT1) 412 is fed back to the input of the frame memory (N-1) 408. As previously described in connection with FIGS. 1 and 2, the look-up tables 412, 416 index or map the inputs to an adjusted or alternate gray level value for each pixel in a frame. The adjusted or alternate gray level values that are output by the look-up tables 412, 416 are used to compensate for the slow response time associated with a display. The display may comprise a liquid crystal display (LCD), for example.

The various aspects of the present invention may be realized using one or more circuits and/or hardware and/or combination of hardware and software. The look-up tables and frame memories previously described may be implemented using hardware and/or software. The one or more circuits or hardware may comprise one or more memories or portions of a memory. The one or more memories or portions of a memory may be used to implement the frame memories or the look-up tables previously described. Therefore, for example, the one or more circuits or hardware or combination of hardware and software may be used to implement and operate the switch, one or more look-up tables (LUTs), and one or more frame memories previously described.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method for displaying video comprising:
processing:
first image data gray level values from a first frame memory; and
second image data gray level values from a second frame memory, said second image data gray level values obtained one frame period prior to said first image data gray level values, said processing performed using one of said one or more first look-up tables, said first frame memory receiving an output from said one of said one or more first look-up tables; and
outputting alternate image data from a second look-up table, wherein said second look-up table uses:
third image data gray level values from a third frame memory; and
current input image data gray level values obtained from a current frame.

2. The method of claim 1 wherein said alternate image data provides gray level values greater than said gray level values of each of said first, second, or third image data gray level values.

3. The method of claim 1 wherein said frame period equals the reciprocal of 60 Hz.

4. The method of claim 1 wherein said frame period equals the reciprocal of 120 Hz.

5. The method of claim 1 wherein said frame period equals the reciprocal of 240 Hz.

6. The method of claim 1 wherein said first frame memory, said second frame memory, and said first, second, and third look-up tables reside in a liquid crystal display (LCD).

7. The method of claim 1 wherein said first frame memory, said second frame memory, and said first, second, and third look-up tables reside in a plasma display panel (PDP).

8. The method of claim 1 wherein said first frame memory, said second frame memory, and said first, second, and third look-up tables reside in an organic light emitting diode display (OLED).

9. A system for displaying video comprising:
one or more circuits operable for, at least:
processing:
first image data gray level values from a first frame memory; and
second image data gray level values from a second frame memory, said second image data gray level values obtained one frame period prior to said first image data gray level values, said processing performed using one of said one or more first look-up tables, said first frame memory receiving an output from said one of said one or more first look-up tables; and
outputting alternate image data from a second look-up table, wherein said second look-up table uses:
third image data gray level values from a third frame memory; and
current input image data gray level values obtained from a current frame.

10. The system of claim 9 wherein said alternate image data provides gray level values greater than said gray level values of each of said first, second, or third image data gray level values.

11. The system of claim 9 wherein said frame period equals the reciprocal of 60 Hz.

12. The system of claim 9 wherein said frame period equals the reciprocal of 120 Hz.

13. The system of claim 9 wherein said frame period equals the reciprocal of 240 Hz.

14. The system of claim 9 wherein said first frame memory, said second frame memory, and said first, second, and third look-up tables reside in a liquid crystal display (LCD).

15. The system of claim 9 wherein said first frame memory, said second frame memory, and said first, second, and third look-up tables reside in a plasma display panel (PDP).

16. The system of claim 9 wherein said first frame memory, said second frame memory, and said first, second, and third look-up tables reside in an organic light emitting diode display (OLED).

17. A method of displaying video comprising:
generating gray level values using a first look-up table (LUT), during a current frame period, by comparing gray level values of:
image data in a current frame, and
spatially corresponding image data provided by a first frame memory, said first frame memory storing gray level values generated from a second look-up table (LUT) two frame periods prior, said gray level values of said second look-up table generated by comparing gray level values of:
spatially corresponding image data provided by a second frame memory, said second frame memory storing gray level values generated from a third look-up table (LUT) one frame period prior, and
spatially corresponding said image data provided by said first frame memory, said gray level values of said third look-up table generated by comparing gray level values of:
spatially corresponding said image data in said current frame, and
spatially corresponding said image data provided by said second frame memory.

18. The method of claim 17 wherein said gray level values generated by said first look-up table (LUT) provide response time compensated gray level values to a video scaler.

19. The method of claim 17 wherein said first frame memory, said second frame memory, and said first, second, and third look-up tables reside in a liquid crystal display (LCD).

20. The method of claim 17 wherein said first frame memory, said second frame memory, and said first, second, and third look-up tables reside in a plasma display panel (PDP).

21. The method of claim 17 wherein said first frame memory, said second frame memory, and said first, second, and third look-up tables reside in an organic light emitting diode display (OLED).

22. A system for displaying video comprising:
one or more circuits operable for, at least:
generating gray level values using a first look-up table (LUT), during a current frame period, by comparing gray level values of:
image data in a current frame, and
spatially corresponding image data provided by a first frame memory, said first frame memory storing gray level values generated from a second look-up table (LUT) two frame periods prior, said gray level values of said second look-up table generated by comparing gray level values of:
spatially corresponding image data provided by a second frame memory, said second frame memory storing gray level values generated from a third look-up table (LUT) one frame period prior, and
spatially corresponding said image data provided by said first frame memory, said gray level values of said third look-up table generated by comparing gray level values of:
spatially corresponding said image data in said current frame, and
spatially corresponding said image data provided by said second frame memory.

23. The system of claim 22 wherein said gray level values generated by using said first look-up table (LUT) provide response time compensated gray level values to a video scaler.

24. The system of claim 22 wherein said first frame memory, said second frame memory, and said first, second, and third look-up tables reside in a liquid crystal display (LCD).

25. The system of claim 22 wherein said first frame memory, said second frame memory, and said first, second, and third look-up tables reside in a plasma display panel (PDP).

26. The system of claim 22 wherein said first frame memory, said second frame memory, and said first, second, and third look-up tables reside in an organic light emitting diode display (OLED).

27. A system for displaying video comprising:
a single frame response time compensation circuitry comprising:
a frame memory;
a first look-up table;
a single frame response time feedback compensation circuitry comprising:
said frame memory;
said first look-up table; and
a second look-up table, said second look-up table generating an output that is fed back and stored in said frame memory, said frame memory transmitting an output to said first look-up table and said second look-up table; and
a switch for switching between said single frame response time compensation circuitry and said single frame response time feedback compensation circuitry, said first look-up table providing an output to a video scaler of a display.
